(19) United States
(12) Patent Application Publication
(10) Pub. No.: US 2011/0228304 A1
(43) Pub. Date: Sep. 22, 2011

(54) IMAGE FORMING APPARATUS AND METHOD FOR CONTROLLING THE SAME

(76) Inventor: Shuko KUWANO, Kanagawa (JP)

(21) Appl. No.: 13/041,522

(22) Filed: Mar. 7, 2011

(30) Foreign Application Priority Data
Mar. 16, 2010 (JP) 2010-060006

(51) Int. Cl. G06F 3/12

(52) U.S. Cl. 358/1.13

(57) ABSTRACT

An image forming apparatus includes an electric power mode control unit that switches an electric power mode between a normal mode in which a job is executed and an electric power saving mode in which no job is executed and power consumption is lower than the normal mode; an electric power mode acquiring unit that acquires electric power mode information of the image forming apparatus, and electric power mode information of at least one other image forming apparatus connected thereto through a network; and a job control unit that, when the image forming apparatus receives a request to execute a job in the electric power saving mode, outputs the request to execute the job to the at least one other image forming apparatus that is in the normal mode based on the electric power mode information of the at least one other image forming apparatus.

### CROSS-REFERENCE TO RELATED APPLICATIONS

The present application claims priority to and incorporates by reference the entire contents of Japanese Patent Application No. 2010-060006 filed in Japan on Mar. 16, 2010.

### BACKGROUND OF THE INVENTION

1. Field of the Invention

The present invention relates to an image forming apparatus and a method for controlling the image forming apparatus.

2. Description of the Related Art

There has been a technique that switches an electric power mode from a normal power consumption mode to an energy saving mode for reducing power consumption when an image forming apparatus receives no job request for a certain period. In the energy saving mode, electric power supply to a section, such as an engine section, is restricted until a job is requested by a host computer connected to the image forming apparatus through a network.

When the host computer requests a job in the energy saving mode, the image forming apparatus returns to be in an electric power mode capable of executing the job, and executes the job. The return from the energy saving mode consumes larger electric power than that the image forming apparatus consumes in the continued normal electric power mode. Accordingly, frequent return from the energy saving mode causes power consumption to further increase.

In order to address the problem, Japanese Patent Application Laid-open No. 2005-313489 discloses an image forming apparatus that reruns from an energy saving mode only when a predetermined condition is satisfied. The predetermined condition includes when a predetermined number of pieces of print data are stored, and when predetermined time elapses. The image forming apparatus disclosed in Japanese Patent Application Laid-open No. 2005-313489 can reduce the number of times of return from the energy saving mode.

The image forming apparatus disclosed in Japanese Patent Application Laid-open No. 2005-313489, however, rather hampers convenience when quick job execution is requested. For example, when a printing job is requested in the energy saving mode, the job is not executed until the predetermined condition is satisfied.

### SUMMARY OF THE INVENTION

It is an object of the present invention to at least partially solve the problems in the conventional technology.

According to an aspect of the present invention, there is provided an image forming apparatus that includes an electric power mode control unit that switches an electric power mode between a normal mode in which a job is executed and an electric power saving mode in which no job is executed and power consumption is lower than the normal mode; an electric power mode acquiring unit that acquires electric power mode information of the image forming apparatus, and electric power mode information of at least one other image forming apparatus connected thereto through a network; and a job control unit that, when the image forming apparatus receives a request to execute a job in the electric power saving mode, outputs the request to execute the job to the at least one other image forming apparatus that is in the normal mode based on the electric power mode information of the at least one other image forming apparatus.

According to another aspect of the present invention, there is provided a method for controlling an image forming apparatus. The method includes switching an electric power mode between a normal mode in which a job is executed and an electric power saving mode in which no job is executed and power consumption is lower than the normal mode; acquiring electric power mode information of the image forming apparatus, and electric power mode information of at least one other image forming apparatus connected thereto through a network; and outputting, when the image forming apparatus receives a request to execute a job in the electric power saving mode, the request to execute the requested job to the at least one other image forming apparatus that is in the normal mode based on the electric power mode information of the at least one other image forming apparatus.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic illustrating an internal structure of an image forming apparatus 100 according to an embodiment;

FIG. 2 is a schematic illustrating an example of an operating section of the image forming apparatus 100;

FIG. 3 is a schematic illustrating a surrounding structure of the image forming apparatus 100 according to the embodiment;

FIG. 4 is a schematic illustrating a functional structure of the image forming apparatus 100 according to the embodiment;

FIG. 5 is a schematic illustrating a network including the image forming apparatus 100;

FIG. 6 is a flowchart illustrating processing in which the image forming apparatus 100 causes another apparatus to execute a printing job when the image forming apparatus 100 is in an energy saving mode;

FIG. 7 is a schematic illustrating an example of a screen promoting input of whether substitute processing is executed by the other apparatuses;

FIG. 8 is a schematic illustrating processing in which an image forming apparatus 100a records a log after another apparatus has executed a printing job;

FIG. 9 is a schematic illustrating processing in which the image forming apparatus 100a notifies an apparatus administrator after another apparatus has executed a printing job;

FIG. 10 is a schematic illustrating processing in which the image forming apparatus 100a notifies a host computer that has instructed a printing job after another apparatus has executed the printing job;

FIG. 11 is a flowchart illustrating processing in which the image forming apparatus 100a executes a printing job after returning to the normal mode when another apparatus cannot execute substitute printing; and

FIG. 12 is a flowchart illustrating processing when no image forming apparatus is available that is in an electric power mode capable of executing printing processing.

### DETAILED DESCRIPTION OF THE PREFERRED EMBODIMENTS

Embodiments according to the present invention will be described below with reference to the accompanying drawings.

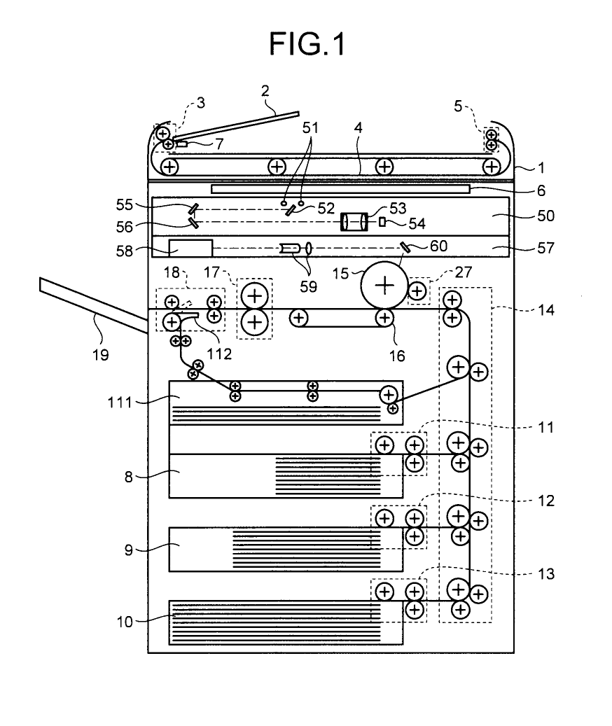

FIG. 1 is a schematic illustrating an internal structure of an image forming apparatus 100 according to an embodiment. The image forming apparatus 100 of FIG. 1 includes an automatic document feeder (hereinafter, referred to as an “ADF”) 1, an exposure glass 6, trays 8, 9, and 10, paper feeding units 11, 12, and 13, a vertical feed unit 14, a photosensitive element 15, a conveying belt 16, a fixing unit 17, an ejecting unit 18, discharge trays 19, a developing unit 27, a scanning unit 50, a writing unit 57, a duplex paper feeding unit 111, and a bifurcating claw 112.

The ADF 1 guides an original placed on an original table 2 onto the exposure glass 6 so that the scanning unit 50 scans images of the original, and discharges the original after scanning. The ADF 1 includes the original table 2, a feeding roller 3, a feeding belt 4, a discharging roller 5, and a document set sensor 7. An original to be scanned by the scanning unit 50 is placed on the original table 2. The feeding roller 3, the feeding belt 4, and the discharging roller 5 are driven or driven as followers so as to carry the original in the ADF 1. The document set sensor 7 detects an original placed on the original table 2.

An original carried by the ADF 1 is placed on the exposure glass 6 so that the scanning unit 50 provided below the exposure glass 6 scans images of the original.

The scanning unit 50 includes an exposure lamp 51, a lens 53, a charge coupled device (CCD) image sensor 54, and mirrors 52, 55, and 56. The exposure lamp 51 irradiates an original placed on the exposure glass 6 with light. The mirrors 52, 55, and 56 guide reflected light of light irradiated on the original to the lens 53. The CCD image sensor 54 receives light imaged by the lens 53, converts the light into an electrical signal, and outputs the signal as image data.

The writing unit 57 includes a laser output unit 58, an imaging lens 59, and a mirror 60. The laser output unit 58 emits a laser beam based on the image signal. The imaging lens 59 and the mirror 60 image the laser beam on the photosensitive element 15.

The photosensitive element 15 is charged, and thereafter a latent image is formed thereon by the laser beam. The latent image is developed by the developing unit 27. The developing unit 27 supplies toner on a surface of the photosensitive element 15 so as to develop the latent image with toner adhering on the latent image.

The conveying belt 16 conveys a medium on which an image formed on the surface of the photosensitive element 15 has been transferred. The fixing unit 17 adds heat and pressure on the medium on which a toner image has been transferred so as to fix toner on the medium. The ejecting unit 18 discharges the medium on which an image has been formed to the discharge tray 19. The ejecting unit 18 has the bifurcating claw 112. The bifurcating claw 112 directs the medium on which the image has been formed to either the duplex paper feeding unit 111 or the discharge tray 19.

Each of the trays 8, 9, and 10 houses a medium for forming images. The trays may house media having different sizes or different feeding directions from each other. The paper feeding units 11, 12, and 13 take out a medium piece by piece from the trays 8, 9, and 10 respectively, and guide the medium to the vertical feed unit 14.

The vertical feed unit 14 carries a medium fed from one of the paper feeding units 11, 12, and 13 to a point where transfer is carried out by the photosensitive element 15, and the conveying belt 16.

The medium on which an image has been formed is discharged to the discharge tray 19.

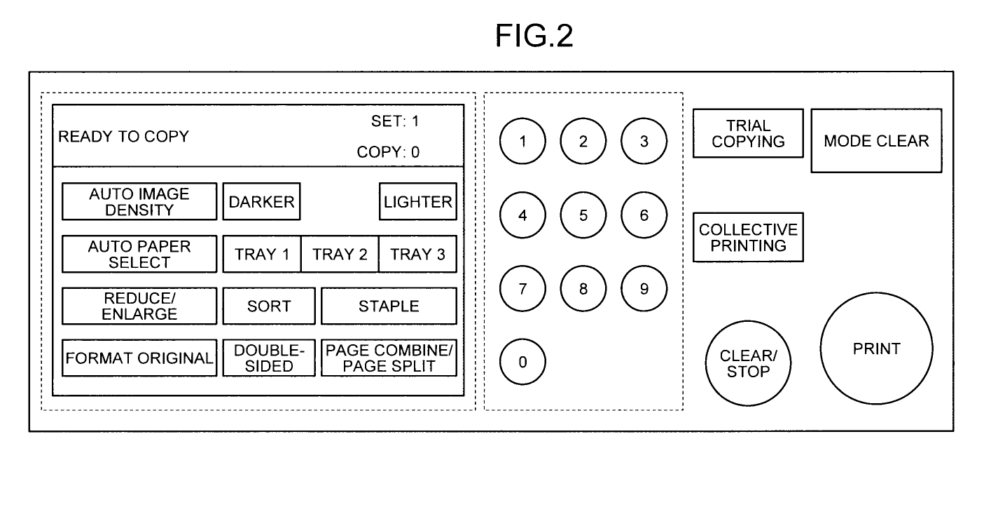

FIG. 2 is a schematic illustrating an example of an operating section of the image forming apparatus 100. The operating section of FIG. 2 includes a touch panel, a numerical keypad, and input keys. The touch panel includes a display indicating whether the image forming apparatus 100 is operable, and buttons promoting input of various kinds of setting in copying jobs. The input keys include a start button, and a clear/stop button.

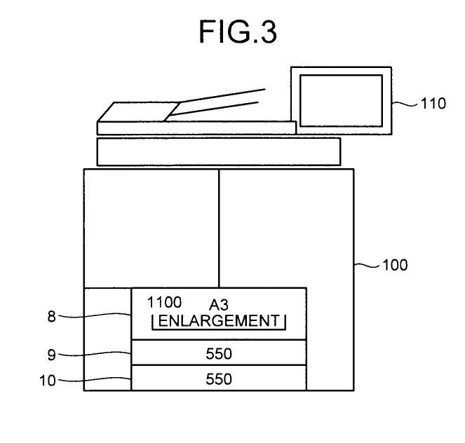

FIG. 3 is a schematic illustrating a surrounding structure of the image forming apparatus 100 according to the embodiment. As illustrated in FIG. 3, the image forming apparatus 100 includes an extended panel 110. The extended panel 110 displays, for example, information relating to the image forming apparatus 100 for an operator. Information displayed by the extended panel 110 may include the same information as displayed on the operating section of FIG. 2.

In FIG. 3, the numbers written in the trays 8, 9, and 10 are the numbers of sheets stacked in the respective trays.

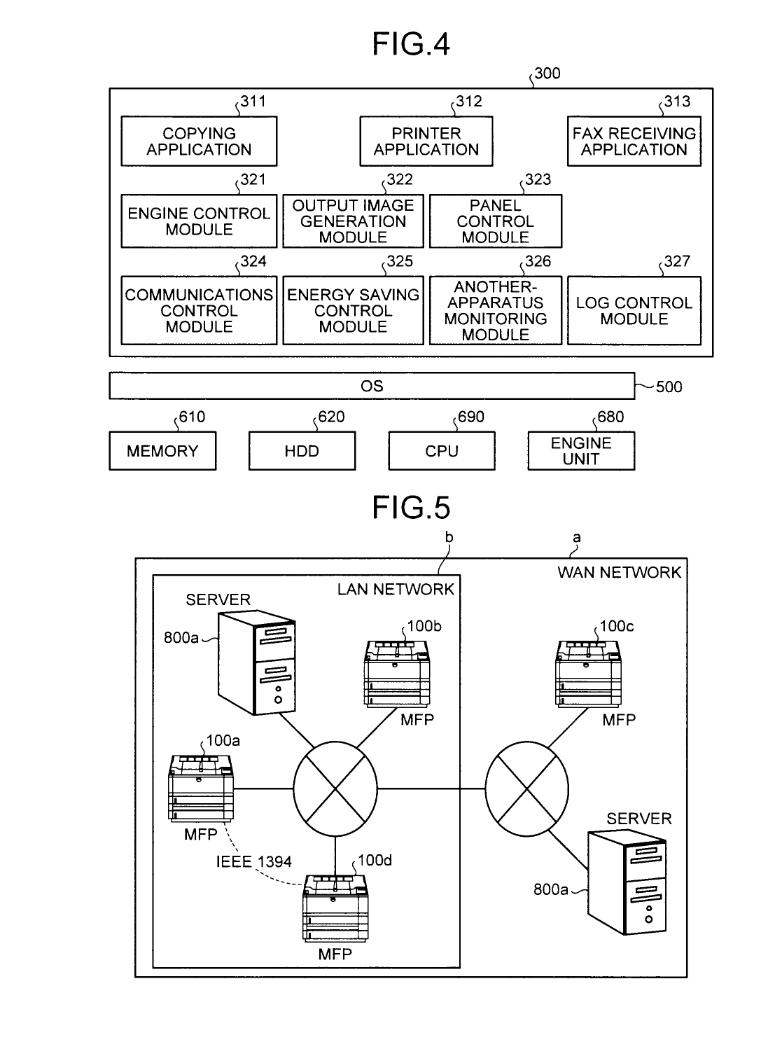

FIG. 4 is a schematic illustrating a functional structure of the image forming apparatus 100 according to the embodiment. The image forming apparatus 100 of FIG. 4 includes a control unit 300, an OS section 500, a memory 610, and a hard disk drive (hereinafter, referred to as an “HDD”) 620, a CPU 690, and an engine unit 680.

The control unit 300 includes at least one application and modules. Each application realizes a job by combining the modules. The modules are provided corresponding to every devices and every functions that are included in the image forming apparatus 100.

The control unit 300 includes a copying application 311, a printer application 312, a facsimile (FAX) receiving application 313, an engine control module 321, an output image generation module 322, a panel control module 323, a communications control module 324, an energy saving control module 325, an another-apparatus monitoring module 326, and a log control module 327.

The copying application 311 implements copying jobs. A copying job is instructed, for example, by input from the operating section. The printer application 312 implements printing jobs according to printing job instructions from a host computer connected through a network, for example. The FAX receiving application 313 implements jobs that print out image data received by facsimile. The FAX receiving application 313 may store image data received by facsimile in the HDD 620, for example.

The engine control module 321 controls the engine unit 680. The output image generation module 322 processes image data so as to produce image data corresponding to output devices. The panel control module 323 produces screens displayed on the operating section illustrated in FIG. 2, and controls the operating section.

The communications control module 324 communicates with the host computer and other image forming apparatuses that are connected through the network.

The energy saving control module 325 switches an electric power mode between a normal mode and an energy saving mode. In the normal mode, jobs can be executed while in the energy saving mode, electric power supplying for some units of the image forming apparatus 100 is stopped. Because of this power supplying stop, execution of some jobs is restricted. Each of the normal mode and the energy saving mode may include a plurality of modes in which units to be supplied with electric power are different from each other.

The another-apparatus monitoring module 326 acquires electric power mode information of other image forming apparatuses connected through the network. The log control module 327 controls logs relating to jobs executed by the image forming apparatus 100. The logs are stored in the HDD 620, for example.

The OS section 500 is utilized by the sections included in the control unit 300 so as to realize controlling of each device. The OS section 500 is used for the CPU 690 executing computer programs.

The memory 610 stores therein image data to be processed by the control unit 300, for example. The HDD 620 stores therein image data to be processed by the control unit 300 and logs to be controlled by the log control module 327, for example. The CPU 690 executes the computer programs in the OS section 500. The execution of the computer programs produces the sections included in the control unit 300. The computer programs to be executed by the CPU 690 are stored in the HDD 620 and developed in the memory 610, for example.

The engine unit 680 includes a scanner, a plotter, and a facsimile, and controls these hardware.

FIG. 5 is a schematic illustrating a network including the image forming apparatus 100. The network of FIG. 5 is a WAN network a. The WAN network a includes a LAN network b. The WAN network a includes a multifunction peripheral (MFP) 100c and a server 800a.

The LAN network b within the WAN network a includes MFPs 100a, 100b, and 100d, and a server 800a. The MFP 100a and the MFP 100d are connected to each other through the Institute of Electrical and Electronics Engineers 1394 (IEEE 1394) interface.

The image forming apparatus according to the embodiment causes other apparatuses to process, as substitution processing, jobs that the image forming apparatus receives during energy saving mode execution. The other apparatuses executing substitution processing are other image forming apparatuses connected through the LAN network and the WAN network.

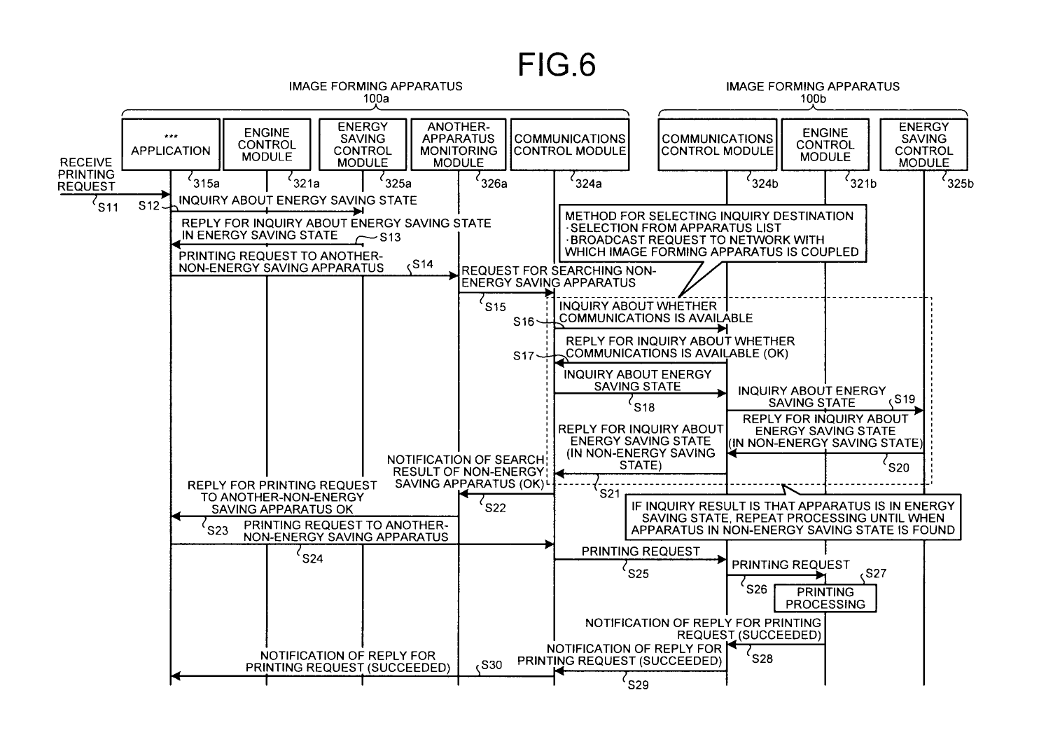

FIGS. 6 to 12 are flowcharts illustrating processing in which the image forming apparatus (MFP) 100a in the energy saving mode requests the image forming apparatus 100b to execute a printing job. In the flowcharts, the indication “*** application 315a” means an application for outputting images. In the following descriptions, “*** application 315a” is described as an “application 315a”.

In the flowcharts, a job to be executed is “printing”. Thus, the descriptions are made below when the application 315a is the printer application 312. However, other applications corresponding to jobs to be executed may be also applicable.

FIG. 6 is a flowchart illustrating processing in which the image forming apparatus 100 causes another apparatus to execute a printing job when the image forming apparatus 100 is in the energy saving mode. At step S11 of FIG. 6, the application 315a receives a printing request input through the operating section.

At step S12 after step S11, the application 315a outputs an inquiry about an energy saving state to an energy saving control module 325a. This inquiry may query whether the electric power mode is the energy saving mode. At step S13 after step S12, the energy saving control module 325a outputs a reply for the inquiry about the energy saving state to the application 315a. The reply includes information indicating that the image forming apparatus 100a is in execution of the energy saving mode.

At step S14 after step S13, the application 315a outputs a request that causes an another-non-energy saving apparatus to execute printing to an another-apparatus monitoring module 326a. The another-non-energy saving apparatus means an image forming apparatus whose electric power mode is not the energy saving mode in other image forming apparatuses connected through the network or the like.

At step S15 after step S14, the another-apparatus monitoring module 326a outputs a request to search for the non-energy saving apparatus to a communications control module 324a. In response to the request, the communications control module 324a executes processing from step S16 to step S20.

At step S16 after step S15, the communications control module 324a outputs, to the image forming apparatus (MPF) 100b, an inquiry about availability of communications (whether the image forming apparatus 100b can communicate with the image forming apparatus 100a). The image forming apparatus 100b receives the inquiry by a communications control module 324b.

At step S17 after step S16, the communications control module 324b outputs a reply for the inquiry about the availability of communications at step S16 to the communications control module 324a. This reply includes information indicating that the communications is available (communications is OK).

At step S18 after step S17, the communications control module 324a outputs an inquiry about an energy saving state to the communications control module 324b. At step S19 after step S18, the communications control module 324b outputs an inquiry about an energy saving state to an energy saving control module 325b.

At step S20 after step S19, the energy saving control module 325b outputs a reply for the inquiry about the energy saving state at step S19 to the communications control module 324b. This reply includes information indicating that the image forming apparatus 100b is in a non-energy saving state. The non-energy saving state means that the apparatus is not in the energy saving mode.

At step S21 after step S20, the communications control module 324b outputs a reply for the inquiry about the energy saving state at step S18 to the communications control module 324a. This reply includes information indicating that the image forming apparatus 100b is in the non-energy saving state.

Processing from step S16 to step S21 is repeated until when another apparatus in non-energy saving state is found. When a plurality of electric power modes are available, processing from step S16 to step S21 is repeated until when a reply is received from another apparatus that is in execution of an electric power mode capable of implementing the function requested at step S11.

At step S22 after step S21, the communications control module 324a notifies the another-apparatus monitoring module 326a of a search result of the non-energy saving apparatuses. This notification includes information indicating that a reply has received from the non-energy saving apparatus (the image forming apparatus 100b). The non-energy saving apparatus is the image forming apparatus whose electric power mode is not the energy saving mode. For example, the image forming apparatus that is in an electric power mode capable of executing a designated job may be available as the non-energy saving apparatus.

At step S23 after step S22, the another-apparatus monitoring module 326a outputs a reply for the request, at step S14, that causes another non-energy saving apparatus to execute printing to the application 315a. This reply includes information including that another non-energy saving apparatus is available for printing, and identification information on the non-energy saving apparatus available for printing.

At step S24 after step S23, the application 315a outputs a request that causes another non-energy saving apparatus to execute printing to the communications control module 324a. This printing request corresponds to the reply obtained at step S23, and may include identification information on the apparatus available for printing.

At step S25 after step S24, the communications control module 324a outputs a printing request to the communications control module 324b of the image forming apparatus 100b. At step S26 after step S25, the communications control module 324b outputs a printing request to an engine control module 321b. At step S27 after step S26, the engine control module 321b executes a printing job based on the request at step S26.

At step S28 after step S27, the engine control module 321b notifies the communications control module 324b of a reply for the printing request at step S26. This notification includes information indicating that the printing job has succeeded.

At step S29 after step S28, the communications control module 324b notifies the communications control module 324a of the image forming apparatus 100a of a reply for the printing request at step S25. This notification includes information indicating that the printing job has succeeded.

At step S30 after step S29, the communications control module 324a notifies the application 315a of a reply for the printing request at step S24. This notification includes information indicating that the printing job has succeeded.

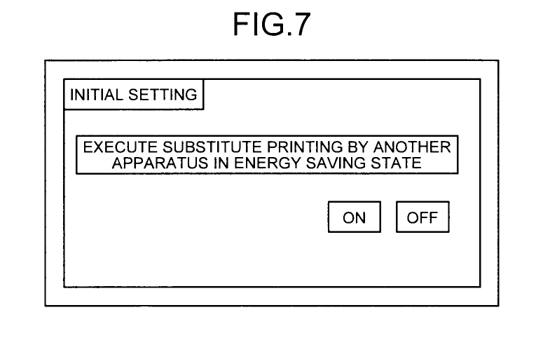

FIG. 7 is a schematic illustrating an example of a screen promoting input of whether substitute processing is executed by another apparatus when a job is instructed during the energy saving mode. The screen of FIG. 7 includes two buttons of “ON” and “OFF” as a response to a message of “substitute printing is executed by another apparatus in energy saving state”. An operator selects either one of two buttons. If “ON” is selected, execution of substitute printing is set while if “OFF” is selected, execution of no substitute printing is set.

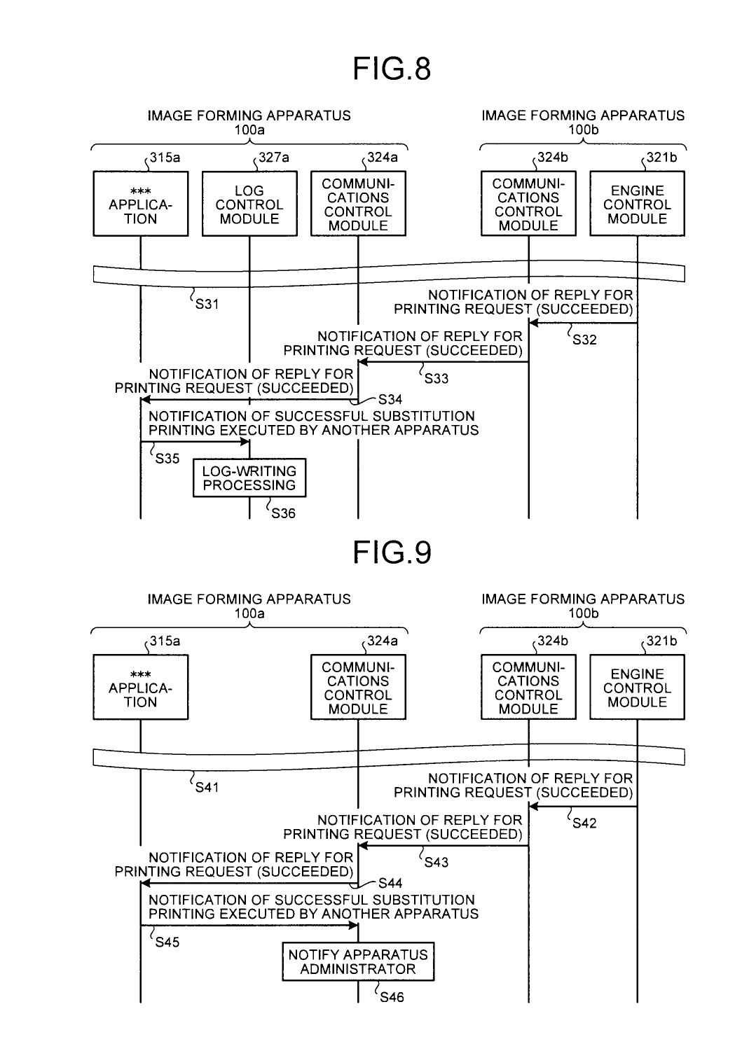

FIG. 8 is a schematic illustrating processing in which the image forming apparatus 100a records a log after the image processing apparatus 100b according to the embodiment has executed the printing job. At step S31 of FIG. 8, processing from step S11 to step S27 of FIG. 6 is executed.

At step S32 after step S31, the engine control module 321b notifies the communications control module 324b of a reply for the printing request at step S26. This notification includes information indicating that the printing job has succeeded.

At step S33 after step S32, the communications control module 324b notifies the communications control module 324a of the image forming apparatus 100a of a reply for the printing request at step S25. This notification includes information indicating that the printing job has succeeded.

At step S34 after step S33, the communications control module 324a notifies the application 315a of a reply for the printing request at step S24. This notification includes information indicating that the printing job has succeeded.

At step S35 after step S34, the application 315a outputs a notification that the substitute printing job has been successfully executed by another apparatus to a log control module 327a. At step S36 after step S35, the log control module 327a records the log of the printing processing having been executed at step S27. This log is stored in the HDD 620, for example.

FIG. 9 is a schematic illustrating processing in which the image forming apparatus 100a notifies an apparatus administrator after the image processing apparatus 100b according to the embodiment has executed the printing job. Processing from step S41 to step S44 of FIG. 9 is the same as that from step S31 to step S34 of FIG. 8, and thus the description thereof is omitted.

At step S45 after step S44, the application 315a outputs a notification that the substitute printing job has been successfully executed by another apparatus to the communications control module 324a. At step S46 after step S45, the communications control module 324a notifies the apparatus administrator. This notification is, for example, a request to send mail or display a screen of the host computer operated by the apparatus administrator.

The apparatus administrator is, for example, an administrator of the image forming apparatus 100a.

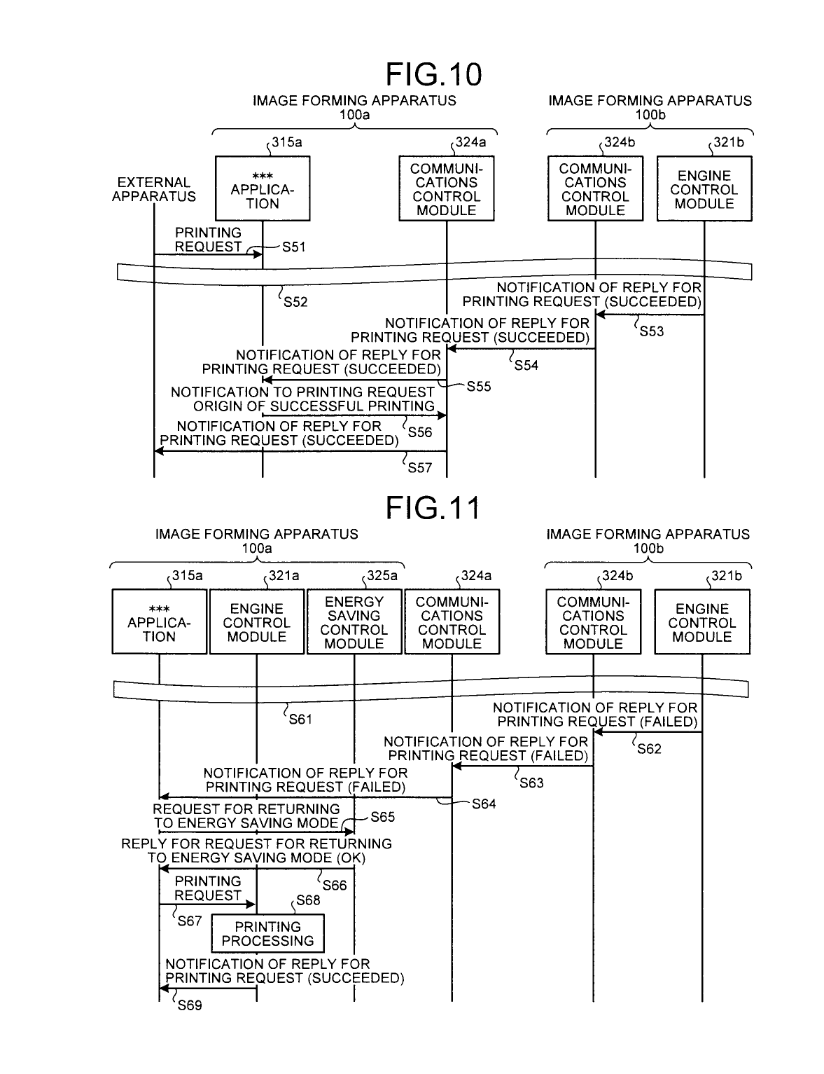

FIG. 10 is a schematic illustrating processing in which the image forming apparatus 100a notifies the host computer that had instructed the printing job after the image processing apparatus 100b according to the embodiment has executed the printing job. At step S51 of FIG. 10, an external apparatus connected to the image forming apparatus 100a requests the image forming apparatus 100a to execute a printing job. This request is input to the application 315a. This request may be received by the communications control module 324a.

Processing from step S52 to step S55 of FIG. 10 is the same as that from step S12 to step S30 of FIG. 6, and thus the description thereof is omitted.

At step S56 after step S55, the application 315a outputs, to the communications control module 324a, a request that causes the communications control module 324a to notify the apparatus that has requested the printing job at step S51 of the success of printing. At step S57 after step S56, the communications control module 324a notifies the external apparatus of a reply for the printing request at step S51. This notification includes information indicating that the printing job has succeeded.

FIG. 11 is a flowchart illustrating processing in which the image forming apparatus 100a executes a printing job after returning to the normal mode when another apparatus cannot execute substitute printing. At step S61 of FIG. 11, processing from step S11 to step S26 of FIG. 6 is executed.

At step S62 after step S61, the engine control module 321b of the image forming apparatus 100b notifies the communications control module 324b of a reply for the printing request. This notification includes information indicating that printing processing has failed.

At step S63 after step S62, the communications control module 324b notifies the communications control module 324a of the image forming apparatus 100a of a reply for the printing request. This notification includes information indicating that printing processing has failed.

At step S64 after step S63, the communications control module 324a notifies the application 315a of a reply for the printing request. This notification includes information indicating that printing processing has failed.

At step S65 after step S64, the application 315a outputs, to the energy saving control module 325a, a request that causes the energy saving control module 325a to return the electric power mode from the energy saving mode to the normal mode. In response to the request, the energy saving control module 325a returns the electric power mode to the normal mode from the energy saving mode.

At step S66 after step S65, the energy saving control module 325a outputs a reply for the energy saving return request at step S65 to the application 315a. This reply includes information indicating that the electric power mode has returned from the energy saving mode to the normal mode.

At step S67 after step S66, the application 315a outputs a printing request to an engine control module 321a. At step S68 after step S67, the engine control module 321a executes printing processing. At step S69 after step S68, the engine control module 321a notifies the application 315a of a reply for the printing request at step S67. This notification includes information indicating that printing processing has succeeded.

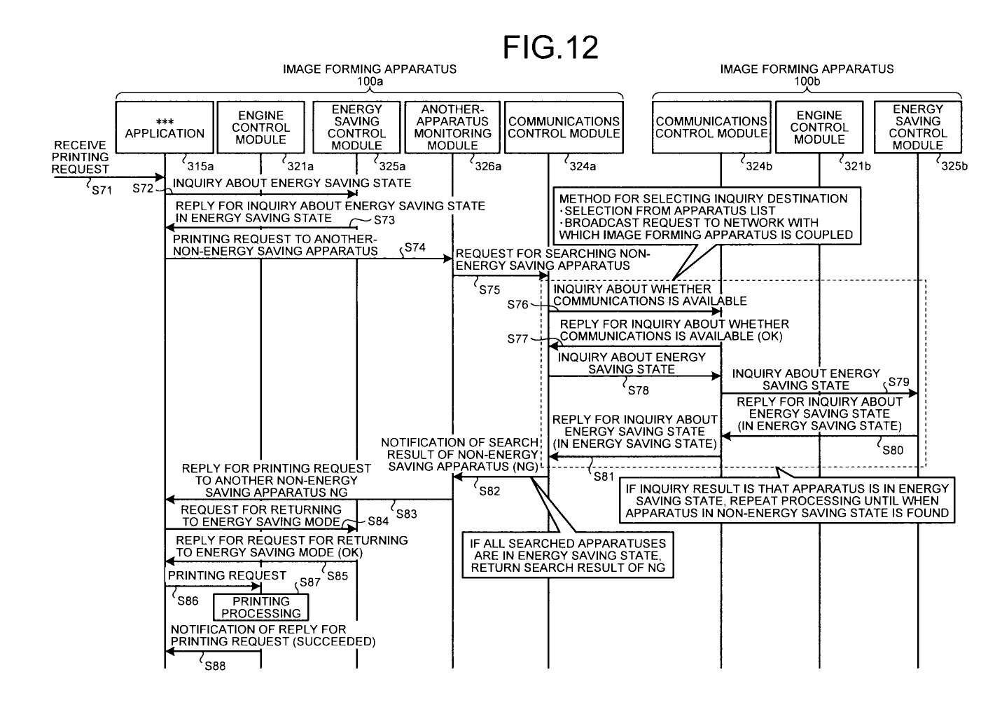

FIG. 12 is a flowchart illustrating processing when no image forming apparatus is available that is in an electric power mode capable of executing printing processing. Processing from step S71 to step S79 of FIG. 12 is the same as that from step S11 to step S19 of FIG. 6, and thus the description thereof is omitted.

At step S80 after step S79, the energy saving control module 325b of the image forming apparatus 100b outputs a reply for the inquiry about the energy saving state to the communications control module 324b of the image forming apparatus 100b. This reply includes information indicating that the image forming apparatus 100b is in the energy saving mode.

At step S81 after step S80, the communications control module 324b outputs a reply for the inquiry about the energy saving state to the communications control module 324a of the image forming apparatus 100a. This reply includes information indicating that the image forming apparatus 100b is in the energy saving mode.

At step S82 after step S81, the communications control module 324a notifies the another-apparatus monitoring module 326a of a search result of the non-energy saving apparatuses. This notification includes information indicating that no non-energy saving apparatus is available.

At step S83 after step S82, the another-apparatus monitoring module 326a outputs a reply for the request that causes the non-energy saving apparatus to execute printing to the application 315a. This notification includes information indicating that the request that causes the no non-energy saving apparatus to execute printing has failed.

Processing from step S84 to step S88, after step S83, of FIG. 12 is the same as that from step S65 to step S69 of FIG. 11, and thus the description thereof is omitted.

The image forming apparatus according to the embodiment of the present invention may be realized with a personal computer (PC), for example. A method for controlling the image forming apparatus according to the embodiment of the present invention is executed by a CPU using a main memory including a RAM as a working area according to programs stored in a ROM or a hard disk drive, for example.

The present invention is not limited to the embodiments described above. The present invention can be modified without departing from the spirit of the present invention.

The present invention exhibits the effect of providing an image forming apparatus that quickly executes jobs with low power consumption and a method for controlling the image forming apparatus.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus, comprising:
an electric power mode control unit that switches an electric power mode between a normal mode in which a job is executed and an electric power saving mode in which no job is executed and power consumption is lower than the normal mode;
an electric power mode acquiring unit that acquires electric power mode information of the image forming apparatus, and electric power mode information of at least one other image forming apparatus connected thereto through a network; and
a job control unit that, when the image forming apparatus receives a request to execute a job in the electric power saving mode, outputs the request to execute the job to the at least one other image forming apparatus that is in the normal mode based on the electric power mode information of the at least one other image forming apparatus.

2. The image forming apparatus according to claim 1, wherein the job control unit further includes a log control unit that acquires a log relating to the request to execute the job to the at least one other image forming apparatus, and controls the log.

3. The image forming apparatus according to claim 2, wherein the job control unit transmits the log to a request source of the job that has been received.

4. The image forming apparatus according to claim 1, wherein, when the at least one other image forming apparatus does not execute the job, the job control unit causes the image forming apparatus to execute the job.

5. The image forming apparatus according to claim 1, wherein, when no communications with the at least one other image forming apparatus that is in the normal mode are available, the electric power mode control unit switches the electric power mode back to the normal mode, and the job control unit causes the image forming apparatus to execute the job.

6. A method for controlling an image forming apparatus, the method comprising:
switching an electric power mode between a normal mode in which a job is executed and an electric power saving mode in which no job is executed and power consumption is lower than the normal mode;
acquiring electric power mode information of the image forming apparatus, and electric power mode information of at least one other image forming apparatus connected thereto through a network; and
outputting, when the image forming apparatus receives a request to execute a job in the electric power saving mode, the request to execute the requested job to the at least one other image forming apparatus that is in the normal mode based on the electric power mode information of the at least one other image forming apparatus.
